(19) United States
(12) Patent Application Publication
(10) Pub. No.: US 2007/0054082 A1
(43) Pub. Date: Mar. 8, 2007

(54) Large package for the transport and storage of insulation elements and combined in modules therefor

(76) Inventors: Ralph Beyer, Jahnstrasse (DE); Guido Steitzer, Munlen-Eichsen (DE); Egon Zinn, Meckenheim (DE); Danilo Evert, Zapel (DE); Edwin Suss, Romerberg (DE)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/552,837

(22) PCT Filed: Apr. 15, 2004
(86) PCT No.: PCT/EP04/04002

§ 371 Date: Aug. 21, 2006

(30) Foreign Application Priority Data
Apr. 15, 2003 (DE) 10317392.7

(51) Int. Cl. G09F 3/00

(52) U.S. Cl. 428/43

(57) ABSTRACT

In a large package for the transport and storage of mineral-wool insulation elements, especially insulation rolls (2) and insulation panels (11), which is made up of adjacent and/or stacked modules (5) that each comprise several, preferably two-to-five or more insulation rolls or insulation-panel packets (1, 10) combined by a film covering, and in which the modules are tied by wrapping elements such as hoods (12) or strap retainers (16) to form a storage and transport unit, the modules (5) are each protected in their entirety against water ingress by a waterproof covering (6) that is preferably permeable to water vapour.

The invention relates to a large package according to the preamble of claim 1 and to an insulation-element module therefor according to the preamble of claim 21.

For the transport and storage of insulation elements, especially insulation rolls and insulation panels of mineral wool, increasing use is being made of large packages, that is, packages comprising a plurality of so-called modules arranged beside each other or stacked one above the other, with each module itself comprising a number of insulation rolls or insulation-panel packets. Both the insulation rolls and the insulation-panel packets, in which several panels are combined to form a transport unit, are packaged—preferably in compacted form—in film. The ends of the insulation elements are for the most part exposed. Packaging of the entity to form a large package is effected by means of a covering, predominantly in the form of wrapping film, such that the large package can be handled with a fork lift or the like.

Large packages of this kind are known, for example, from EP 0 220 980 A1, in which insulation rolls or insulation-panel packets are packaged to modules, these modules are stacked one above the other and are then covered with a hood-like plastic-film wrapping. In this way, the largely exposed ends of the individual insulation rolls or insulation-panel packets are covered and protected on the outside by a hood-like covering or else by wrapping film, as a rule stretch film. Mineral-wool insulation elements are often hydrophobic as a result of a water-repellent agent having been added. However, non-uniform distribution of the water-repellent agent and resultant capillary water uptake by the covered mineral wool can never be completely ruled out. Water uptake impairs the properties of the insulation material, however, and for this reason the outer covering of film on large packages of this kind can also be of closed configuration (DE 198 58 201 A1). This measure is intended to prevent the ingress of rain water or dirty water when the large package is set down on the ground. This is essential, particularly in view of the fact that owing to pollution in the air, rain water can show a certain degree of aggressiveness towards the fibres of the insulation elements. With time, this can even cause damage to the fibre structure and lead to impairment of the insulation elements' properties. DE 198 58 201 A1 describes a large package made up, in particular, of a number of insulation panels and including a pallet-like structure. The large package is encased in a closed covering of film. The covering is made of a material permeable to water vapour so that water vapour resulting from condensation can escape from the interior of the large package to the outside. Apart from the fact that applying a covering to packaging units of some size, especially to large packages, is a fairly difficult undertaking requiring special packaging facilities, large packages of this sort have the added disadvantage that although the insulation rolls or insulation-panel packets are protected by the covering over the large package while they are encased within, they are not protected—especially at their ends—once the large package is opened or, for example, damaged, and the sub-units are stored and transported on site. There is then a risk of water ingress, along with the associated disadvantages.

The object of the invention is to propose a form of packaging for the transport and storage of insulation products, especially of mineral wool, which effectively prevents water from ingressing into the insulation products—whether in the form of a large package or a modular component thereof—and which is simpler in construction and hence cheaper than conventional forms of packaging.

This object is established according to the invention by the features contained in the characterizing parts of claims 1 and 18, with useful developments of the invention being characterized by the features contained in the sub-claims.

According to the invention, water is prevented from ingressing into a large package by protecting the individual modules within the large package in their entirety by a waterproof i. e. watertight covering that is preferably permeable to water vapour, but not permeable to water or other fluids. The covering encases the individual modules completely, so that the insulation rolls or insulation-panel packets contained therein are completely secure against water ingress. It is to advantage if the covering is composed of film such as shrink film. However, the film-like covering encasing the insulation rolls or insulation-panel packets can also be closed by overlapping the ends of the film and then bonding or welding them together in the overlap area.

The covering is waterproof i. e. watertight but preferably permeable to water vapour, so that moisture exchange from the interior to the exterior is possible. This permeability to water vapour ensures that in the case of inevitable water condensation during storage of the large package, the moisture within the modules or the large package can escape at elevated temperatures to the outside. Another advantage of the measures according to the invention consists in that the large package can be packaged in a manner which is by all means conventional. In addition, the modules can also be held together to form a large package by using strap retainers or hoop. It goes without saying that also a large package of the latter type can then be packaged with a film covering, should this be necessary. Of further advantage here is that should the outer film packaging around the large package be damaged, water is prevented from ingressing into any of the undamaged modules because they are effectively protected by the module covering. All in all, by implementing the measures of the invention, i.e. using only strap retainers or hoop to hold the individual modules together, the outer film covering for the large package can be dispensed with and hence the cost of the packaging reduced. With this form of packaging for a large package, it is also possible to dispense completely with a pallet and to transport the entire unit, including the strap retainers, etc., by means of a crane or grippers.

As provided for in a further development of the invention, the covering for both the large package and the individual modules is expediently composed of a material which is moisture-adaptive, i.e. whose permeability to water vapour varies as a function of the ambient humidity. It is expedient here to configure the material such that when the relative humidity of the atmosphere surrounding the covering is in the range from 30 to 50%, the material has a water-vapour diffusion resistance of 2 to 5 m diffusion-equivalent air-layer thickness, and when the relative humidity is in the range from 60 to 80%, which corresponds to summer conditions, it has a water-vapour diffusion resistance of <1 m diffusion-equivalent air-layer thickness. When film of this kind is used, the perfect drying out of moisture and condensation water within the modules is ensured at all times. As a result, a sound guarantee that the insulation elements will retain their insulating properties even over extensive storage periods can be given. In the case of a moisture-adaptive covering, it is expedient if this, too, is composed of film; polyamides, preferably polyamide 3, polyamide 4 or polyamide 6 are particularly suitable. If the film used is of this kind, it need not be thrown away but can be used for another purpose, for example as an adaptive vapour barrier for high-pitched roofs.

Further useful developments of the invention ensue from the measures in the other subclaims.

Preferred embodiments of the invention will now be explained by reference to the drawings.

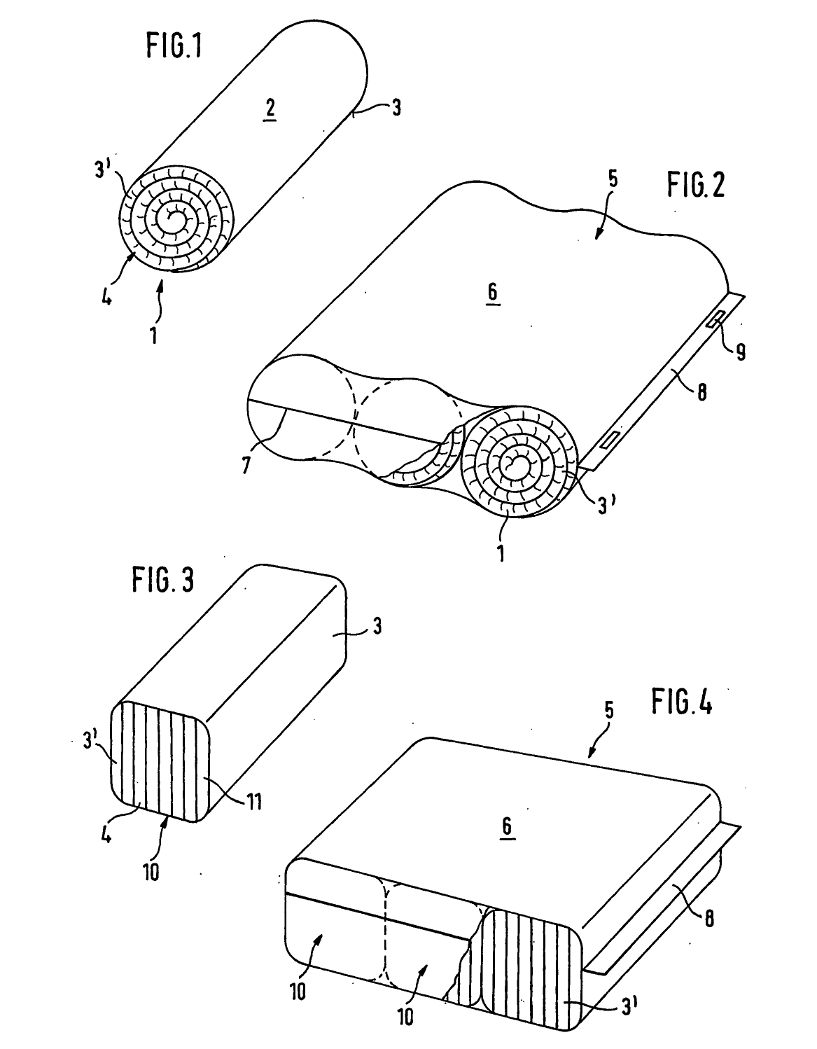

FIG. 1 is a perspective view of an insulation blanket rolled under compaction conditions to an insulation roll;

FIG. 2 shows a module comprising three insulation rolls according to FIG. 1;

FIG. 3 shows an insulation packet packaged under compaction conditions and comprising several adjacent or stacked insulation panels;

FIG. 4 is again a perspective view, here of a module comprising three insulation packets according to FIG. 3;

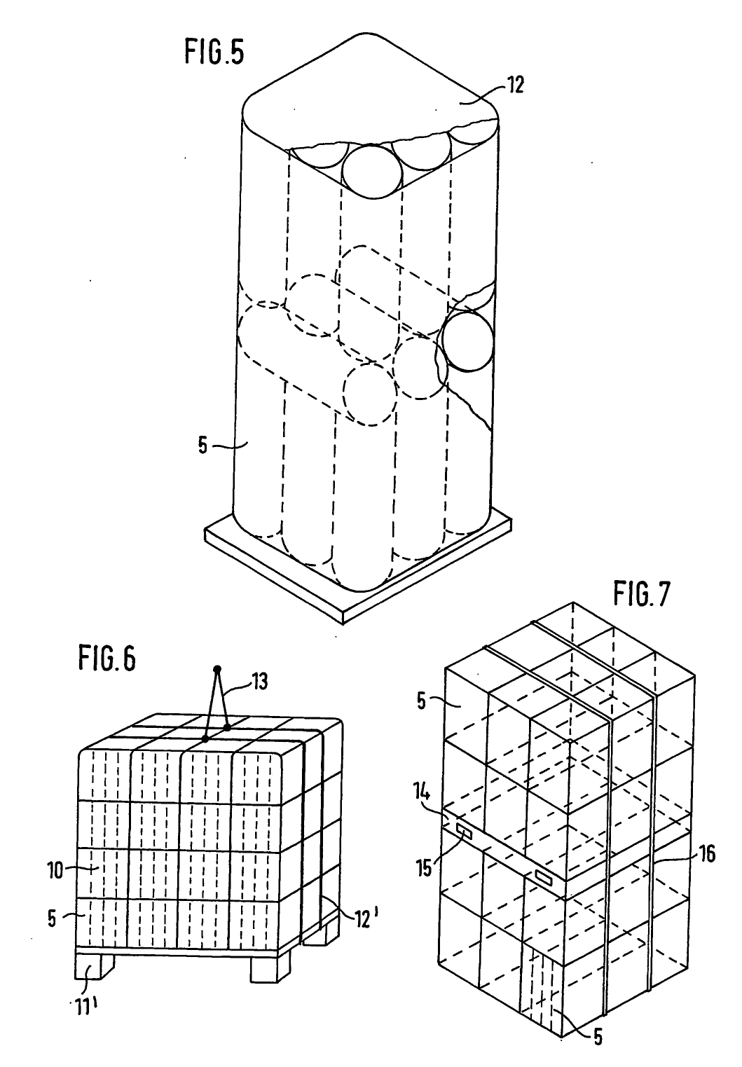

FIG. 5 is likewise a diagrammatic illustration of a large package, which is made up of several modules stacked or arranged beside each other and which forms a transport and storage unit;

FIG. 6 is likewise a diagrammatic illustration of a large package, in which modules that each comprise four insulation-panel packets are stacked and held on a pallet by strap retainers;

FIG. 7 is likewise a diagrammatic illustration of a large package, in which an interposing layer is provided in the middle, with two layers of modules on each side, as a handling point for a fork lift, the entire palletless large package being held together by strap retainers.

FIG. 1 shows an insulation blanket made of mineral wool, in particular glass fibres that has been rolled under compaction conditions to a roll 1 and is wrapped in conventional manner in film 3 to retain the compacted form during transport and storage. The film 3 completely covers the cylindrical outer surface of the roll 1 and covers a part—indicated by the reference numeral 3′—of the ends 4 of the insulation roll 2. As covering for the insulation roll, shrink film or film that is bonded or heat-sealed in the overlap area is used. Suitable film materials include polyethylene, polyvinyl chloride, polyester, polypropylene and/or polyamide. The main function of the film 3 is to uphold the compacted state of the tightly rolled roll, so that it needs as little space as possible during transport and storage. The film 3 serves simultaneously to accommodate product names, which can either be printed directly on the film or on appropriate labels.

On account of the need to save space, insulation rolls are generally rolled under compaction conditions that produce compaction ratios up to 1:7 and more. In choosing the compaction ratio, however, care must be taken that the fibre composite is not destroyed and that perfect elastic recovery of the unrolled insulation blanket to its nominal thickness is ensured.

FIG. 2 shows an embodiment, according to the invention, of the module, which is illustrated here as a packaging unit for three insulation rolls of the type shown in FIG. 1. The module in general is identified by the reference numeral 5. The module is formed by encasing the insulation rolls 1, each of which, in turn, is wrapped in film 3, in a completely closed covering which, in the embodiment according to FIG. 2, is formed by film 6. This covers the exterior circumferential surfaces of the adjacent insulation rolls 1 as well as the ends 4 of the insulation rolls, the ends 4 already being partially covered by the film 3 in the areas denoted by 3′. In other words, to form the module 5, the packet of insulation rolls is completely enclosed or packaged in a wrapping composed of the film 6; the module as such can also be subjected to a preceding compaction step. In the seam area, denoted by 7, the overlapping areas of film are welded, shrunk, bonded or otherwise suitably joined together. As is shown on the right of FIG. 2, the film wrapping 6 is expediently configured such that an exposed edge 8, formed by film overlap, projects outwards and serves for handling the module during transport and storage. To this end, it is useful to provide additional handling means in the rib-like projecting edge 8, for example eyelets 9, which facilitate manual gripping and handling of the module 5. This film excess for the formation of the edge 8 can, if necessary, be suitably reinforced—for example by interposing a nonwoven fabric such as glass-fibre nonwoven fabric. It is to advantage, however, to use the film excess at the end of the packet, in the area denoted by 7, to form a rib-like or tongue-like edge corresponding to the illustrated edge 8.

Although three insulation rolls 1 are packaged to a module 5 in the embodiment illustrated, it is within the scope of the invention for a module to comprise two to four insulation rolls, or more, provided the module is limited to a size that enables it to be transported by one person.

The embodiment according to FIG. 3 involves an insulation packet 10 composed of adjacent or stacked insulation panels 11; like in the embodiment illustrated in FIG. 1, the long, outer surface of the packet is covered with film 3 whose folded-over area 3′ only partially covers the two ends 4 of the packet. As wrapping, use can again be made of shrink film, as in this embodiment, or else of film that is bonded or otherwise suitably joined in the overlap area.

FIG. 4 again shows the module 5, which is formed by a covering of film 6 that completely encloses the insulation packets 10, i.e. both on the long side and at the ends. In the embodiment according to FIG. 4, too, a rib-like edge 8 to facilitate handling is advantageously formed by a film excess. In the embodiment illustrated in FIG. 4, three insulation packets—each of which can contain two to ten, or more, insulation panels—are combined to a module 5, and, as such, are again compacted and then enclosed in film. A module 5 can comprise two to four insulation packets, or more, although the same limitation applies in this context as to the embodiment of FIGS. 1 and 2.

What is essential is that the module covering, which is composed of film in both embodiments, resembles a casing and completely encloses the insulation rolls or packets contained therein, so that the ingress of any water whatsoever, especially rainwater, is prevented by the waterproof film. The covering can, moreover, be designed such that it is permeable to water vapour. To this end, it is beneficial to use a moisture-adaptive covering, that is, a covering whose water-vapour permeability varies as a function of the ambient humidity. It is expedient here to use a material for the covering 6 that has a water-vapour diffusion resistance (s_{d} value) of 2 to 5 m diffusion-equivalent air-layer thickness when the relative humidity of the atmosphere surrounding the covering is in the range from 30 to 50%, and a water-vapour diffusion resistance (s_{d} value) which is <1 m diffusion-equivalent air-layer thickness when the relative humidity is in the range from 60 to 80%. A humidity of 30 to 50% is generally encountered under winter conditions. On account of the diffusion resistance that is established under these conditions, the covering, which is preferably composed of film, becomes impermeable and prevents the transport of moisture. Under summer conditions, with a humidity of 60 to 80%, the film becomes permeable again and any moisture that has collected in the interior as a result of water condensing can escape to the outside. Thus it is ensured that no moisture is transported from the exterior to the interior, but that any moisture that collects in the interior will always dry up by escaping to the outside. As material, film based on polyamide, especially polyamide 3, polyamide 4 or polyamide 6, has proved to be particularly suitable. Of course, it is also possible to use other other moisture-adaptive materials, in particular of polyester, polypropylene or polyethylene, or materials of copolyamide or polyvinyl chloride. In connection with the water-vapour diffusion resistance of moisture-adaptive material used for the covering, attention is drawn to the German DIN standard 52615, in which measuring techniques for water-vapour diffusion resistance are defined.

It is beneficial to configure the films used such that they are also UV-resistant, this being of particular advantage when the large packages are used in southerly countries with a lot of sun. The films used can advantageously be rendered resistant to UV light by coloring the base material, for example with soot. UV stabilizers such as hydroxybenzophenone or hydroxyphenylbenzotriazole can also be used to enhance the light resistance.

By virtue of the easy-to-handle modules being encased, so to speak, in a waterproof covering, it suffices to use conventional wrapping materials such as strap retainers, hoop or film tape to make up a large package comprising several stacked and/or adjacent modules. On account of the modules being fixed in position in this way, and of their waterproof packaging, an outer covering for the large package can advantageously be dispensed with. The large package need only be wrapped in such manner that the packet of modules is held together firmly and can be reliably handled in the usual way, for example with a fork lift.

FIG. 5 illustrates a large package whose bottom layer is made up of three modules standing upright, each in turn consisting of three insulation rolls; on top of this layer there is a horizontally positioned module comprising three adjacent insulation rolls, and on top of this, another layer comprising three adjacent modules standing upright. A large package of this kind, in which the modules are arranged crosswise, i.e. with intersecting axes, is characterized by very high stability. High stability can also be achieved by omitting the crosswise-disposed middle layer and, instead, arranging the top module layer such that it is offset by 90° relative to the bottom layer. Of course, the large package is not restricted to a crosswise arrangement of this kind; much rather, the invention is also applicable to modules stacked in other ways. In the embodiment shown in FIG. 5, the modules are combined to a large package by a hood-like covering 12. To illustrate the arrangement more clearly, the individual modules and the insulation rolls contained therein are shown with dashed lines, so that the crosswise arrangement, i.e. the orientation of the modules in vertical and horizontal manner, is evident. For additional clarity, parts of the film covering 12 of the large package are broken away to show the interior. The large package can be transported on a pallet which, if necessary, can also be integrated in the covering 12.

In place of the hood-like covering 12 shown in FIG. 5, strap retainers or similar retaining means can also be used. FIGS. 6 and 7 diagrammatically illustrate two more large packages provided with such retaining means.

In the large package illustrated diagrammatically in FIG. 6, three modules 5′, each composed of four insulation-panel packets 10, are stacked one above the other on a pallet 11. They are held on the pallet 11 by just two strap retainers 12. Since the modules are enclosed, as provided for in the invention, in a waterproof film, an outer covering is unnecessary, which is an economic advantage. An additional advantage is that a large package made up in this way can also be transported by means of a crane or a hook on a fork lift, as indicated by reference numeral 13. Once the strap retainers have been unfastened at a construction site or in a D.I.Y. store, the individual modules 5′ can be conveniently handled and displayed without any danger of their being exposed to the weather—after all, they have a waterproof packaging—before they are processed or sold.

The large package illustrated diagrammatically in FIG. 7, finally, shows a packaging variant which does not require a pallet at the bottom. Instead, an interposing layer 14 is provided in the middle, with two layers of modules 5 on each side, as a lifting point for a fork lift. The interposing layer 14 can be made of cardboard, for example, with insert openings 15, or is formed by a separate insulation panel of mineral wool or plastic, into which the prongs of a fork lift can penetrate. This palletless large package is held together by strap retainers 16 and can be left in the open on damp ground without any risk of water ingress, since, as provided for in the invention, the individual modules 5 and hence also the bottom layer thereof have a waterproof packaging.

1-23. (canceled)

24. A large package for the transport and storage of insulation components comprising:
modules arranged side by side, each module comprising a plurality of insulation elements combined by a film covering, the modules being tied by wrapping elements to form a storage and transport unit;
the modules being entirely protected against water ingress by a waterproof covering completely encasing the modules.

25. The large package according to claim 24, wherein:
the waterproof covering completely encloses the insulation elements.

26. The large package according to claim 24, wherein:
the waterproof covering is composed of a film or foil.

27. The large package according to claim 26, wherein:
the film or foil comprises polyethylene, polyvinyl chloride, polypropylene, polyester or polyamide.

28. The large package according to claim 24, wherein:
the waterproof covering is composed of a moisture-adaptive material whose water-vapor diffusion resistance is dependent on a relative humidity of a surrounding atmosphere.

29. The large package according to claim 28, wherein:
when the relative humidity of the atmosphere surrounding the film covering is in the range from 30 to 50%, the material has a water-vapor diffusion resistance of 2 to 5 m diffusion-equivalent air-layer thickness and when the relative humidity is in the range from 60 to 80%, the material has a water-vapor diffusion resistance of <1 m diffusion-equivalent air-layer thickness.

30. The large package according to claim 28, wherein:
the material is composed of film or foil.

31. The large package according to claim 30, wherein:
the material is film or foil comprising polyamide.

32. The large package according to claim 24, wherein:
at least two of the modules are arranged alternately upright and lying flat.

33. The large package according to claim 24, wherein:
the modules are arranged upright but offset relative to each other.

34. The large package according to claim 24, wherein:
the insulation elements are packaged under a compression ratio above 1:3.5.

35. The large package according to claim 24, wherein:
the waterproof covering is welded, shrunk or bonded in an overlap area.

36. The large package according to claim 24, wherein:
the waterproof covering is composed of film which is self-adhesive in an overlap area and which welds on making contact, without additionally requiring an adhesive.

37. The large package according to claim 35, wherein:
an excess portion of the waterproof covering projects outwards, at least in parts, to form a rib-like gripping edge, thus making it possible to grip the module at the gripping edge.

38. The large package according to claim 37, wherein:
the rib-like gripping edge is provided with openings spaced to allow the gripping edge to be grabbed.

39. The large package according to claim 37, wherein:
the excess portion as measured from a glueline or weld to an edge of the film is at least 5 cm.

40. The large package according to claim 24, wherein:
the modules do not have a pallet and the modules are stacked and have a waterproof packaging, with the modules being held together by retainers.

41. The large package according to claim 40, wherein:
an interposing layer is provided between layers of the modules as a lifting point for a fork lift.

42. The large package according to claim 41, wherein:
the interposing layer comprises cardboard, mineral wool in the form of a panel, or plastic.

43. The large package according to claim 24, wherein:
the waterproof covering is permeable to water vapor.

44. The large package according to claim 24, wherein:
each insulation element comprises an insulation roll.

45. The large package according to claim 24, wherein:
each insulation element comprises a plurality of insulation panels.

46. A module for the transport and storage of insulation elements contained in a covering, with the module being protected in its entirety against water ingress by a waterproof covering that completely encases the module.

47. The module according to claim 46, wherein:
the covering is permeable to water vapor.

48. A method of transporting and using insulation elements comprising:
providing a module for the transport and storage of the insulation elements;
covering the module with a waterproof covering, with the module being protected in its entirety against water ingress by the waterproof covering that completely encases the module; and
disposing of the waterproof covering by using the waterproof covering as a vapor barrier for a high-pitched roof.

49. The method according to claim 48, wherein:
the waterproof covering is permeable to water vapor.
